(19) United States
(12) Patent Application Publication
(10) Pub. No.: US 2024/0300510 A1
(43) Pub. Date: Sep. 12, 2024

(54) NOTIFICATION APPARATUS

(71) Applicant: ISUZU MOTORS LIMITED, Yokohama-shi (JP)

(72) Inventor: Keisuke KIMURA, Yokohama-shi (JP)

(21) Appl. No.: 18/583,733

(22) Filed: Feb. 21, 2024

(30) Foreign Application Priority Data
Mar. 6, 2023 (JP) 2023-033595

(51) Int. Cl. B60W 50/14; B60L 58/13

(52) U.S. Cl. CPC B60W 50/14; B60L 58/13; B60L 2250/16; B60W 2050/146; B60W 2510/244

(57) ABSTRACT

A notification apparatus includes: an acquisition section that acquires first information on a first amount of power used for travel of a vehicle that operates with power, and second information on a second amount of power used for equipment in the vehicle for a purpose other than the travel; and a control section that notifies a user of the first amount of power and the second amount of power in accordance with the first information and the second information so that the first amount of power and the second amount of power can be compared.

### TECHNICAL FIELD

The present disclosure relates to a notification apparatus.

### BACKGROUND ART

In an existing vehicle driven by an internal combustion engine, energy generated by the internal combustion engine has been used not only for driving the vehicle, but also for vehicle equipment (air conditioning, operation of a body section). Fuel efficiency of such a vehicle is represented as a distance traveled per unit of fuel consumed (fuel economy) and can be managed for the entire travel of the vehicle. A driver, or a manager that manages the vehicle manages fuel economy and can thus perform feedback on an operation plan and an operation method so as to achieve efficient driving.

Furthermore, in a vehicle including a battery, for example, the power consumption of the battery is managed, and the above-described feedback can thus be performed. For example, PTL 1 discloses an apparatus capable of calculating a distance that a vehicle can travel in the future in accordance with a battery power consumption rate and a remaining battery level.

### CITATION LIST

### Patent Literature

PTL 1
Japanese Patent Application Laid-Open No. 2011-142757

### SUMMARY OF INVENTION

### Technical Problem

In the vehicle including the battery, however, power of the battery is used not only for travel of the vehicle, but also for vehicle equipment. In the existing vehicle, only the travel of the vehicle and the power consumption of the entire vehicle including the vehicle equipment are managed, and there is thus a certain limit to a configuration in which feedback is performed on an operation plan and an operation method.

The present disclosure provides a notification apparatus that can appropriately manage the power consumption of a vehicle.

### Solution to Problem

A notification apparatus according to the present disclosure includes: an acquisition section configured to acquire first information on a first amount of power used for travel of a vehicle configured to operate with power, and second information on a second amount of power used for equipment in the vehicle for a purpose other than the travel; and a control section configured to notify a user of the first amount of power and the second amount of power in accordance with the first information and the second information so that a comparison between the first amount of power and the second amount of power is possible.

### Advantageous Effects of Invention

The present disclosure enables the power consumption of the vehicle to be appropriately managed.

### BRIEF DESCRIPTION OF DRAWINGS

FIG. 1 is a diagram illustrating a vehicle including a notification apparatus according to an embodiment of the present disclosure;

FIG. 2 is a block diagram illustrating the notification apparatus according to the present embodiment;

FIG. 3 is a diagram illustrating a display example of a usage ratio for the amount of power;

FIG. 4 is a diagram illustrating a display example of a usage ratio for the amount of power;

FIG. 5 is a graph illustrating a display example of a usage ratio for the amount of power;

FIG. 6 is a graph illustrating a display example of a usage ratio for the amount of power;

FIG. 7 is a diagram illustrating a server including a notification apparatus according to a modification, and a vehicle;

FIG. 8 is a block diagram illustrating the notification apparatus according to the modification;

FIG. 9 is a graph illustrating a display example of a usage ratio for the amount of power; and

FIG. 10 is a block diagram illustrating the notification apparatus according to a modification.

### DESCRIPTION OF EMBODIMENTS

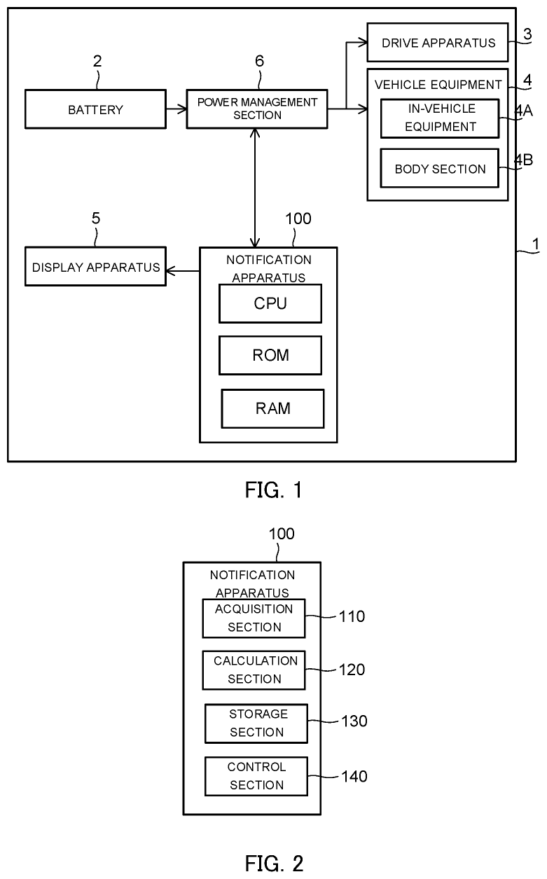

An example of an embodiment of the present disclosure will be described in detail below with reference to the drawings. FIG. 1 is a diagram illustrating vehicle 1 including notification apparatus 100 according to the embodiment of the present disclosure. FIG. 2 is a block diagram illustrating notification apparatus 100 according to the present embodiment.

As illustrated in FIG. 1, vehicle 1 is a vehicle, such as an electric vehicle or hybrid vehicle, that can travel with battery 2. Vehicle 1 has a function of notifying a user of a usage ratio of power used in vehicle 1 for each of objects that have used power. Vehicle 1 includes drive apparatus 3, vehicle equipment 4, display apparatus 5, power management section 6, and notification apparatus 100 in addition to battery 2.

Drive apparatus 3 is a motor for driving vehicle 1 to cause vehicle 1 to travel.

Vehicle equipment 4 is equipment that is provided in vehicle 1 and can operate with power. Vehicle equipment 4 includes in-vehicle equipment 4A and body section 4B. Note that vehicle equipment 4 is not limited to this and may further include multiple pieces of equipment. In the present embodiment, vehicle 1 is a vehicle equipped with a body (for example, a truck) including body section 4B.

In-vehicle equipment 4A is air-conditioning equipment. Note that in-vehicle equipment 4A may be any equipment that is provided in vehicle 1 and can operate with power.

Display apparatus 5 is a display apparatus, for example, of a car navigation apparatus provided in vehicle 1. Note that display apparatus 5 may be a display provided in an external terminal, such as a tablet a driver has.

Power management section 6 manages power supplied from battery 2 to drive apparatus 3 and vehicle equipment 4. For example, power management section 6 is an electronic control unit (ECU) provided in vehicle 1. Power management section 6 monitors first information on a first amount of power supplied from battery 2 to drive apparatus 3 and second information on a second amount of power supplied from battery 2 to vehicle equipment 4 and outputs the first information and the second information to notification apparatus 100.

It can be said that the first amount of power is the amount of power used for travel of vehicle 1. It can be said that the second amount of power is the amount of power used for equipment in vehicle 1 for a purpose other than the travel of vehicle 1. The second amount of power includes the amount of power used for in-vehicle equipment 4A and the amount of power used for body section 4B. Power management section 6 may manage the amount of power used for in-vehicle equipment 4A and the amount of power used for body section 4B in distinction from each other.

Notification apparatus 100 includes a central processing unit (CPU), a read only memory (ROM), a random access memory (RAM), and an input-output circuit (not illustrated). Notification apparatus 100 notifies the user of, of power used in vehicle 1, power (the first amount of power) used for travel and power (the second amount of power) used, for example, by the vehicle equipment for a purpose other than the travel. Furthermore, notification apparatus 100 notifies the user of a usage ratio of power used in vehicle 1 for each object. As illustrated in FIG. 2, notification apparatus 100 includes acquisition section 110, calculation section 120, storage section 130, and control section 140. The CPU reads a program from the ROM to implement functions of acquisition section 110, calculation section 120, storage section 130, and control section 140.

Acquisition section 110 acquires the first information on the first amount of power and the second information on the second amount of power from power management section 6. For example, acquisition section 110 may acquire the first information and the second information during operation of vehicle 1.

Calculation section 120 calculates a usage ratio for the first amount of power and a usage ratio for the second amount of power in accordance with the first information and the second information. A usage ratio refers to the amount of power to the entire amount of power consumed by the vehicle. For example, calculation section 120 calculates the sum of the first amount of power and the second amount of power. Calculation section 120 regards, as a usage ratio for the first amount of power, a value obtained by dividing the first amount of power by the calculated sum and regards, as a usage ratio for the second amount of power, a value obtained by dividing the second amount of power by the calculated sum.

Furthermore, in a usage ratio for the second amount of power, calculation section 120 may calculate a usage ratio for the amount of power used for in-vehicle equipment 4A and a usage ratio for the amount of power used for body section 4B separately.

In storage section 130, a usage ratio for the first amount of power and a usage ratio for the second amount of power that have been calculated by calculation section 120 are stored.

Control section 140 notifies the user of the first amount of power and the second amount of power in accordance with the first information and the second information so that the first amount of power and the second amount of power can be compared. Specifically, control section 140 displays, in accordance with the first information and the second information, usage ratios for the first amount of power and the second amount of power that have been used since the start of operation of vehicle 1 side by side on display apparatus 5.

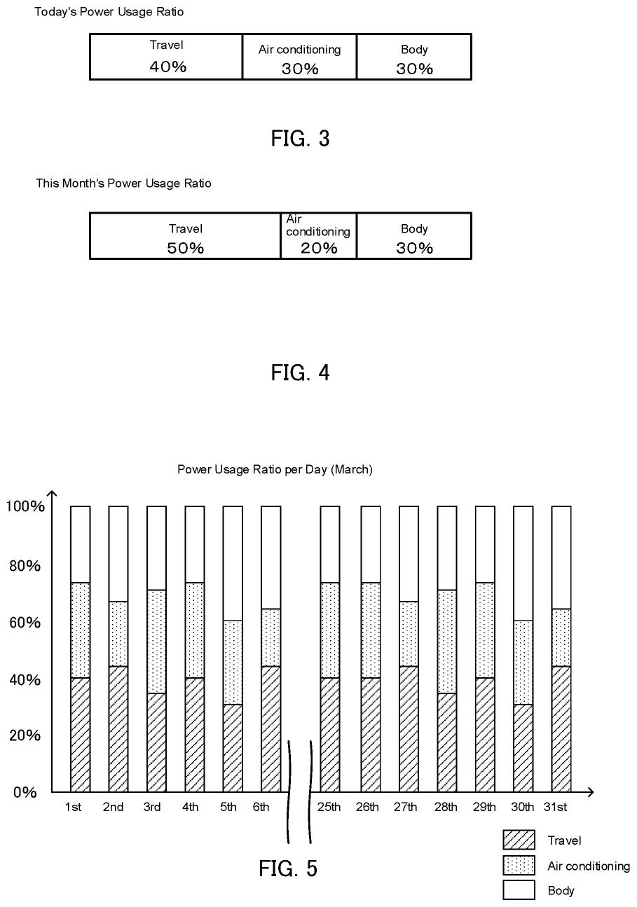

For example, as illustrated in FIG. 3, on display apparatus 5, an example is displayed in which a usage ratio associated with “travel” is 40%, a usage ratio associated with “air conditioning” is 30%, and a usage ratio associated with “body” is 30%. Note that a usage ratio may be a usage ratio in a case where the power consumption of the day is 100%.

This allows a driver (user) to grasp usage ratios for respective objects to which power is supplied at first sight. As a result, the power consumption of vehicle 1 can be appropriately managed. For example, when a usage ratio for the first amount of power is relatively large, it can be considered that the user takes care to drive using regenerative energy. Furthermore, when a usage ratio for the second amount of power, particularly a usage ratio for in-vehicle equipment 4A, is relatively large, it can be considered that the user takes care to drive with energy conservation, such as a reduction in air volume in air conditioning, in mind.

That is, in the present embodiment, when the power consumption of vehicle 1 is appropriately managed, feedback can be performed on an operation plan and an operation method so that the user can drive efficiently.

Note that, although, in the above-described embodiment, the first amount of power and the second amount of power that have been used since the start of operation are displayed in accordance with the first information and the second information that have been acquired during operation, the present disclosure is not limited to this. For example, the first amount of power and the second amount of power may be displayed not during operation but for each operation. Each operation may be, for example, operation of an entire day or operation from when power supply to vehicle 1 is started to when power supply is stopped.

Furthermore, as illustrated in FIG. 4, a mean value of usage ratios for the first amount of power and a mean value of usage ratios for the second amount of power in a fixed period may be displayed. For example, FIG. 4 illustrates an example in which monthly mean values are displayed. Specifically, an example is illustrated in which a usage ratio associated with “travel” is 50%, a usage ratio associated with “air conditioning” is 20%, and a usage ratio associated with “body” is 30%.

As for these mean values, for example, a usage ratio for the amount of power per day of usage of each month may be stored in storage section 130. Furthermore, calculation section 120 may calculate a mean value in accordance with usage ratios stored in storage section 130.

Furthermore, as illustrated in FIG. 5, a usage ratio for the first amount of power and a usage ratio for the second amount of power may be displayed per day of usage. In FIG. 5, the vertical axis represents usage ratio, and the horizontal axis represents date. In FIG. 5, the first amount of power (the amount of power associated with travel) is hatched with diagonal lines. In the second amount of power, a usage ratio for the amount of power used for in-vehicle equipment 4A is marked with dots, and a usage ratio for the amount of power used for body section 4B is not marked with any pattern. In FIG. 5, an example of a usage ratio for the amount of power per day of usage of March is illustrated.

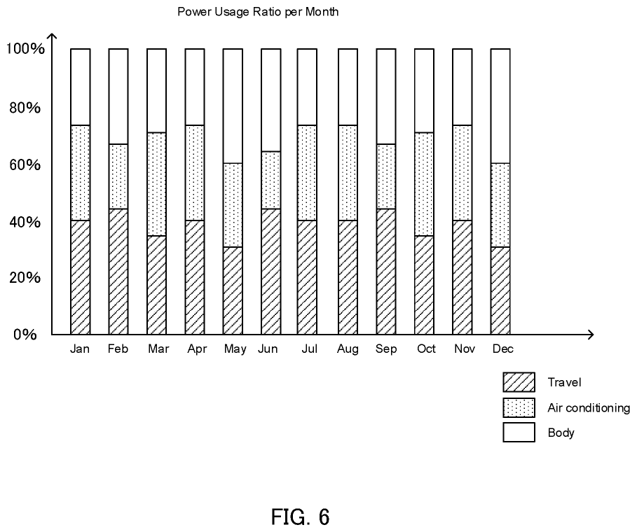

Furthermore, as illustrated in FIG. 6, a usage ratio for the first amount of power and a usage ratio for the second amount of power may be displayed per month of usage. In FIG. 6, the vertical axis represents usage ratio, and the horizontal axis represents month. In FIG. 6, the first amount of power (the amount of power associated with travel) is hatched with diagonal lines. In the second amount of power, a usage ratio for the amount of power used for in-vehicle equipment 4A is marked with dots, and a usage ratio for the amount of power used for body section 4B is not marked with any pattern.

These usage ratios may be calculated by calculation section 120 per month of usage and stored in storage section 130.

Furthermore, although, in the above-described embodiment, usage ratios for the first amount of power and the second amount of power are displayed on display apparatus 5 of vehicle 1, the present disclosure is not limited to this. For example, an external apparatus, such as server 10 that manages vehicle 1, of vehicle 1 may perform control to display the usage ratios. Examples of the external apparatus may include any apparatuses, such as a personal computer (PC), and a mobile terminal, such as a smartphone, that can perform control according to the above-described embodiment.

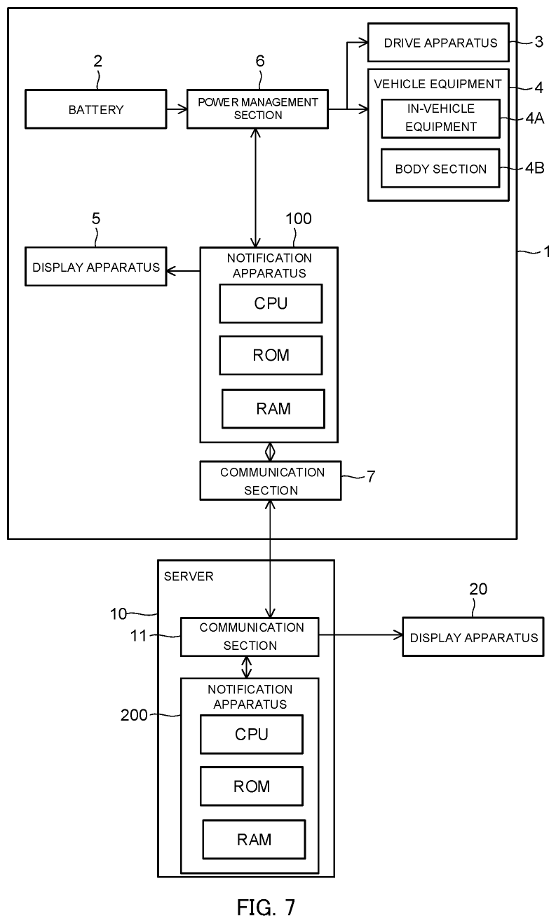

Vehicle 1 illustrated in FIG. 7 includes communication section 7 that can communicate with server 10. Communication section 7 transmits the first information and the second information that are managed by power management section 6 to server 10.

Server 10 includes communication section 11 that can communicate with vehicle 1, and notification apparatus 200.

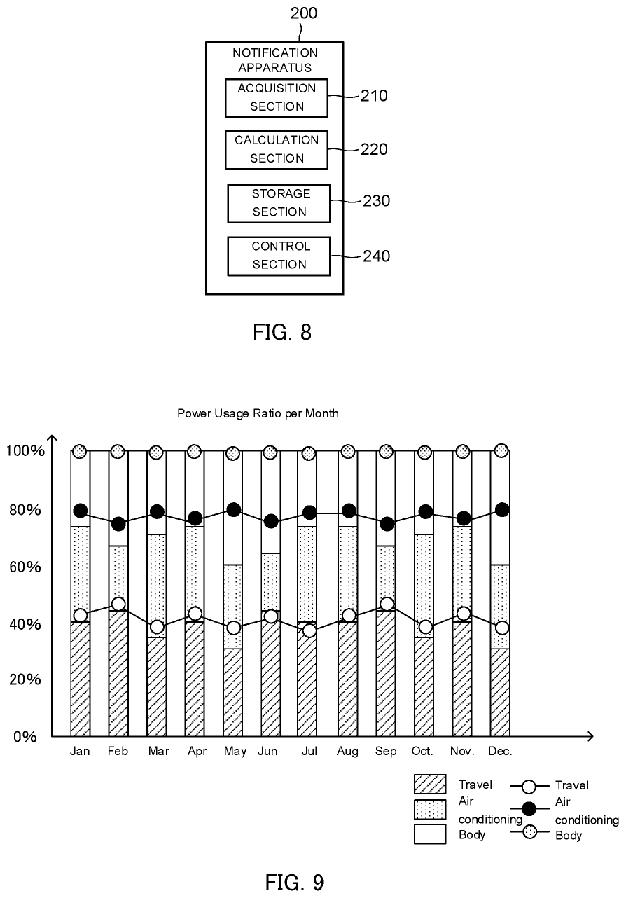

Notification apparatus 200 includes a CPU, a ROM, a RAM, and an input-output circuit (not illustrated). Notification apparatus 200 notifies the user of a usage ratio of power used in vehicle 1 for each object. As illustrated in FIG. 8, notification apparatus 200 includes acquisition section 210, calculation section 220, storage section 230, and control section 240.

Acquisition section 210 acquires the first information on the first amount of power and the second information on the second amount of power from communication section 11. Calculation section 220 is similar to calculation section 120 illustrated in FIG. 2, and storage section 230 is similar to storage section 130 illustrated in FIG. 2.

Control section 240 notifies the user of the first amount of power and the second amount of power in accordance with the first information and the second information so that the first amount of power and the second amount of power can be compared. Specifically, control section 240 causes, in accordance with the first information and the second information, via communication section 11, external display apparatus 20 to display a usage ratio for the first amount of power and a usage ratio for the second amount of power.

Examples of external display apparatus 20 include display apparatus 5 of vehicle 1, a PC of an administrator of server 10, and a mobile terminal, such as a smartphone of the user.

Thus, even in a case where information on power for vehicle 1 is acquired externally, server 10 can appropriately manage the power consumption of vehicle 1.

Furthermore, when an external apparatus, such as server 10, is used, pieces of information from more than one vehicle 1 can be managed.

When pieces of information from more than one vehicle 1 are managed, for example, a mean value of the amounts of power used for individual vehicles can be displayed.

For example, as illustrated in FIG. 9, control section 240 displays a mean value of the amounts of power used for more than one vehicle 1 managed by server 10 while displaying a power usage ratio per month of usage for certain vehicle 1. In FIG. 9, an example is illustrated in which a mean value of usage ratios for the amounts of power associated with travel is denoted by a white circle, a mean value of usage ratios for the amounts of power associated with air conditioning is denoted by a black circle, and a mean value of usage ratios for the amounts of power associated with the body is denoted by a circle filled with dots.

Furthermore, although, in the above-described embodiment, pieces of information on usage ratios for the individual amounts of power are displayed side by side on the display apparatus, the present disclosure is not limited to this. For example, any information, such as a difference between the first amount of power and the second amount of power, may be displayed on the display apparatus as long as the first amount of power and the second amount of power can be compared.

Furthermore, although, in the above-described embodiment, the display apparatus displays information on a usage ratio for the amount of power, the present disclosure is not limited to this. For example, a voice generation apparatus (such as a car navigation apparatus or a smartphone) may notify the user of information on the amount of power by voice.

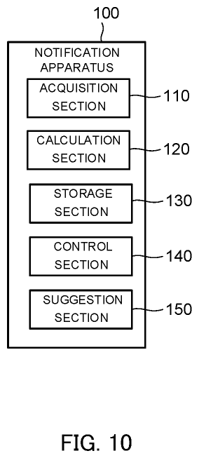

Furthermore, although, in the above-described embodiment, the user is only notified of information on a usage ratio for the amount of power, the present disclosure is not limited to this. For example, as illustrated in FIG. 10, suggestion section 150 may be provided that makes a suggestion for an operation method for vehicle 1 in accordance with a usage ratio for the amount of power.

For example, when a usage ratio for the first amount of power is relatively large, suggestion section 150 may suggest taking care to drive using regenerative energy. Furthermore, when a usage ratio for in-vehicle equipment 4A in the second amount of power is relatively large, suggestion section 150 may suggest a reduction in air volume in air conditioning. The way suggestion section 150 makes a suggestion may be any way in which suggested details can be conveyed to the user, such as a way in which suggested details are displayed on display apparatus.

Furthermore, although, in the above-described embodiment, the user is notified of a usage ratio for the amount of power, the present disclosure is not limited to this. The user may be notified of the very amount of power.

Furthermore, although, in the above-described embodiment, notification of, as the second amount of power, the amount of power associated with air conditioning and the amount of power associated with the body is provided so as to make a distinction between them, the present disclosure is not limited to this. Notification of the amount of power associated with air conditioning and the amount of power associated with the body may be provided without making a distinction between them.

Furthermore, although, in the above-described embodiment, the second amount of power includes the amount of power used for air conditioning and the amount of power used for the body, the present disclosure is not limited to this. The second amount of power may include the amount of power associated with other vehicle equipment. Furthermore, as for a vehicle including no body section, the second amount of power does not have to include the amount of power associated with a body.

Additionally, the above-described embodiment is merely an example of an embodiment for implementing the present disclosure, and the technical scope of the present disclosure is not to be construed in a limited manner due to the above-described embodiment. That is, the present disclosure can be implemented in various forms without departing from the gist thereof or a principal feature thereof.

This application is entitled and claims the benefit of Japanese Patent Application No. 2023-033595, filed on Mar. 6, 2023, the disclosure of which including the specification, drawings and abstract is incorporated herein by reference in its entirety.

### INDUSTRIAL APPLICABILITY

A notification apparatus according to the present disclosure is useful as a notification apparatus that can appropriately manage the power consumption of a vehicle.

1. A notification apparatus, comprising:
an acquisition section configured to acquire first information on a first amount of power used for travel of a vehicle configured to operate with power, and second information on a second amount of power used for equipment in the vehicle for a purpose other than the travel; and
a control section configured to notify a user of the first amount of power and the second amount of power in accordance with the first information and the second information so that a comparison between the first amount of power and the second amount of power is possible.

2. The notification apparatus according to claim 1, further comprising
a calculation section configured to calculate a usage ratio for the first amount of power and a usage ratio for the second amount of power in accordance with the first information and the second information,
wherein the control section notifies the user of the usage ratio for the first amount of power and the usage ratio for the second amount of power so that a comparison between the usage ratio for the first amount of power and the usage ratio for the second amount of power is possible.

3. The notification apparatus according to claim 1,
wherein the control section displays the first amount of power and the second amount of power on a display apparatus so that a comparison between the first amount of power and the second amount of power is possible.

4. The notification apparatus according to claim 3,
wherein the control section displays information representing the first amount of power and information representing the second amount of power side by side on the display apparatus.

5. The notification apparatus according to claim 3,
wherein the control section displays the first amount of power and the second amount of power per day of usage on the display apparatus.

6. The notification apparatus according to claim 3,
wherein the control section displays the first amount of power and the second amount of power per month of usage on the display apparatus.

7. The notification apparatus according to claim 3,
wherein the control section displays the first amount of power and the second amount of power for each operation of the vehicle on the display apparatus.

8. The notification apparatus according to claim 3,
wherein the acquisition section acquires the first information and the second information during operation of the vehicle, and
wherein the control section displays, in accordance with the first information and the second information, the first amount of power and the second amount of power that have been used since start of operation of the vehicle on the display apparatus.

9. The notification apparatus according to claim 1,
wherein the vehicle includes a body section, and
wherein the second amount of power includes an amount of power used for in-vehicle equipment in the vehicle and an amount of power used for the body section of the vehicle.
